(19) United States
(12) Patent Application Publication
(10) Pub. No.: US 2010/0301239 A1
(43) Pub. Date: Dec. 2, 2010

(54) Water flushing device for floor toilet

(76) Inventor: Meng-Meng Chen, Changhua Hsien (TW)

Correspondence Address: CHARLES E. BAXLEY, ESQUIRE, 90 JOHN STREET, SUITE 309, NEW YORK, NY, 10038, US

(21) Appl. No.: 12/455,469

(22) Filed: Jun. 2, 2009

(51) Int. Cl. F16K 35/00

(52) U.S. Cl. 251/89

(57) ABSTRACT

A water flushing device includes a membrane engaged onto an upper portion of a housing for blocking the housing, a casing extended in the housing for forming an outer peripheral space between the housing and the casing, a valve device for selectively blocking and opening an opening of the membrane, and a barrel mounted to the membrane and engaged in the casing and having a passage communicative with the bore of the barrel and the chamber of the casing for allowing the water in the bore of the barrel to flow out through the passage of the barrel and to flow out into the chamber of the casing and for preventing the valve device from being opened by the internal water pressure in the barrel or in the casing.

### BACKGROUND OF THE INVENTION

1. Field of the Invention

The present invention relates to a water flushing device for a floor toilet, and more particularly to a water flushing device for a floor toilet including a structure for allowing the valve device to be suitably blocked or shut off or closed and for preventing the valve device from being kept opened by the internal water pressure.

2. Description of the Prior Art

Typical water flushing devices for the floor toilets comprise a housing disposed on the floor and coupled to a water reservoir for receiving the water from the water reservoir, the housing including an outlet port directed or coupled to the floor toilet bowl, a valve device disposed in the housing for controlling the water to flow from the housing to the floor toilet bowl, and an actuating handle or lever coupled to the valve device for actuating or operating the valve device to control the water to flow from the housing to the floor toilet bowl.

The valve device may be actuated or operated by the actuating handle or lever that is extended out of the housing in order to open the water flowing passage formed or provided in the housing when required, and/or the valve device may be actuated or operated by the water flowing into the housing in order to control the water to flow out of the housing.

However, when the actuating handle or lever is disengaged from the valve device, an internal water pressure may be occurred or generated within the water flowing passage in the housing and may keep the valve device in the open status such that the water may still flow out of the housing due to the opened valve device and such that the valve device may not be suitably block or shut off the typical water flushing devices for the floor toilets.

The present invention has arisen to mitigate and/or obviate the afore-described disadvantages of the conventional water flushing devices for the floor toilets.

### SUMMARY OF THE INVENTION

The primary objective of the present invention is to provide a water flushing device including an improved structure for allowing the valve device to be suitably blocked or shut off or closed and for preventing the valve device from being kept opened by the internal water pressure.

In accordance with one aspect of the invention, there is provided a water flushing device comprising a housing including an inlet port for receiving water, and including an outlet port, and including a casing extended in the housing for forming an outer peripheral space between the housing and the casing, and for forming a bore within the casing, and the outer peripheral space formed and located between the housing and the casing being communicative with the inlet port for receiving the water from the inlet port, a membrane including an outer peripheral portion engaged onto an upper portion of the housing for blocking the upper portion of the housing, and including an opening formed therein, and including an orifice formed therein, a valve device for selectively blocking and opening the opening of the membrane, and a barrel mounted to the membrane and engaged in the chamber of the casing, and including a passage formed therein and communicative with the bore of the barrel and the chamber of the casing for allowing the water in the bore of the barrel to flow out through the passage of the barrel and to flow out into the chamber of the casing and for selectively releasing the internal water pressure within the bore of the barrel and/or in the chamber of the casing and for preventing the valve device from being kept opened by the internal water pressure within the bore of the barrel and/or in the chamber of the casing.

The barrel includes a bore communicative with the opening of the membrane, and the valve device includes a stem extended into the bore of the barrel. An actuating device may further be provided and attached and secured to the housing and includes an actuating rod extended into the housing and engageable with the stem of the valve device for selectively tilting the stem and the valve device relative to the barrel.

The actuating device includes an actuating lever extended out of the housing for operating the actuating rod to selectively tilt the stem and the valve device relative to the barrel. The membrane includes an inner peripheral rim and an outer peripheral rim for forming and defining a middle peripheral portion between the inner peripheral rim and the outer peripheral rim.

The membrane includes a plurality of bulges formed and located in the middle peripheral portion for reinforcing the membrane. The membrane includes a blade engaged in the inner peripheral rim for reinforcing the membrane.

The membrane includes a blade engaged in the outer peripheral rim for reinforcing the membrane. A cover may further be provided and engaged onto the upper portion of the housing and engaged with the outer peripheral rim of the membrane for forming a sealed compartment between the membrane and the cover.

A cap may further be provided and engaged with the barrel and engaged with the inner peripheral rim of the membrane for securing the barrel to the membrane. A first gasket and at least one second gasket may further be provided and selectively engaged into the orifice of the membrane, and include a bore of different inner diameter for adjusting a water flushing speed through the orifice of the membrane and through the bores of the first and the second gaskets.

The first and the second gaskets each include two outer peripheral flanges for engaging with the membrane and for anchoring or mounting the first and the second gaskets to the membrane.

The first and the second gaskets each include an inclined surface formed in one of the outer peripheral flanges thereof for engaging the first and the second gaskets into the orifice of the membrane.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a water flushing device in accordance with the present invention;

FIG. 2 is a partial cross sectional view of the water flushing device;

FIG. 3 is an enlarged partial exploded view of the water flushing device; and

FIG. 4 is a further partial exploded view of the water flushing device.

### DETAILED DESCRIPTION OF THE PREFERRED EMBODIMENT

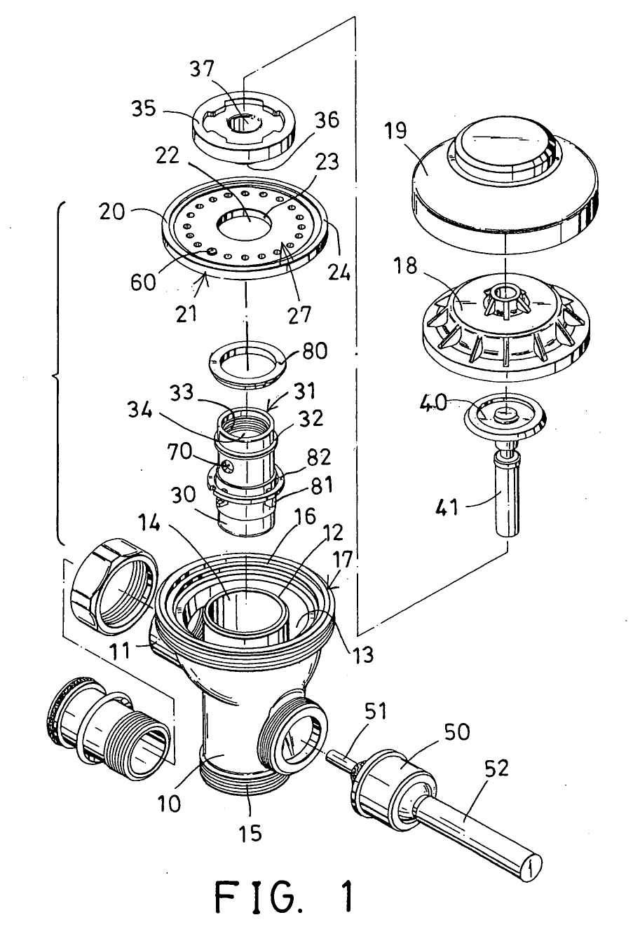

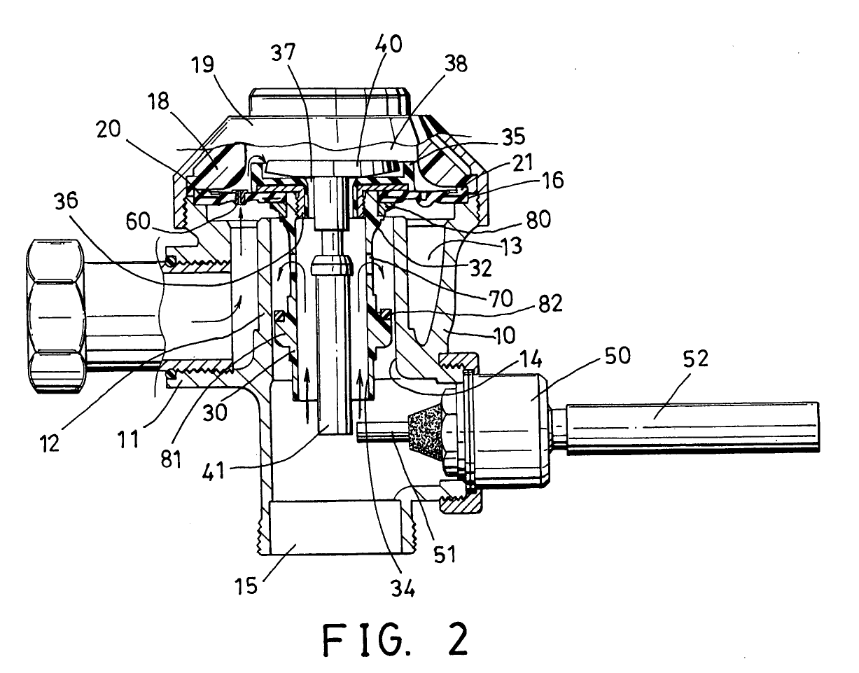

Referring to the drawings, and initially to FIGS. 1 and 2, a water flushing device in accordance with the present invention comprises a housing 10 for being disposed on the floor (not shown), and including an inlet port 11 for coupling to a water reservoir (not shown) and for receiving the water from the water reservoir, the housing 10 includes a cylindrical casing 12 extended in the housing 10 for forming an outer peripheral space 13 between the housing 10 and the casing 12, and for forming a chamber 14 within the casing 12, and the outer peripheral space 13 formed and located between the housing 10 and the casing 12 is communicative with the inlet port 11 for receiving the water from the inlet port 11, the housing 10 includes an outlet port 15 directed or coupled to the floor toilet bowl (not shown) for selectively supplying the water to the floor toilet bowl.

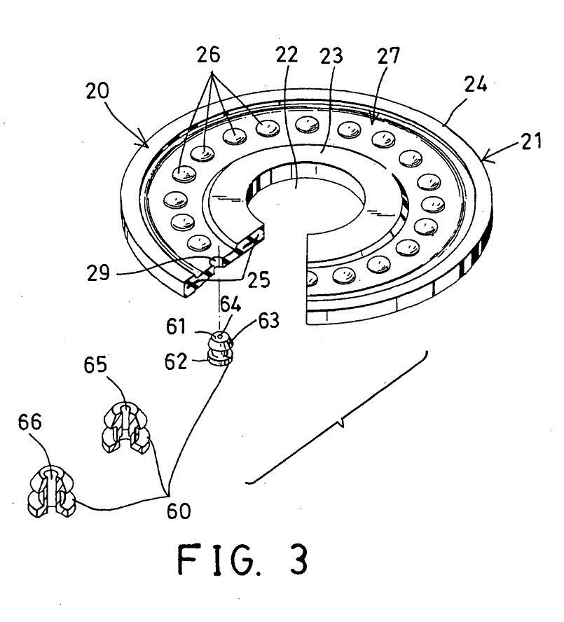

The housing 10 further includes an inner peripheral shoulder 16 formed in the upper portion 17 thereof and located above or higher than the upper portion of the casing 12 (FIG. 2). As shown in FIGS. 1-4, a soft or resilient film or membrane 20 includes an outer peripheral portion 21 engaged onto or into the peripheral shoulder 16 or the upper portion 17 of the housing 10 for blocking or sealing the upper portion of the housing 10 and/or the casing 12, and includes a center opening 22 formed therein. It is preferable that the membrane 20 includes an inner peripheral rim 23 and an outer peripheral rim 24 each having a resilient blade 25 engaged therein (FIG. 3) for reinforcing the membrane 20, and includes a number of swellings or bulges 26 formed thereon and located in the middle peripheral portion 27 that is formed or defined between the rims 23, 24 for further reinforcing the membrane 20, and includes one or more orifices 29 formed in the middle peripheral portion 27 thereof (FIG. 3).

One or more barrels 30 each include an upper portion 31 selectively or changeably engaged into the opening 22 of the membrane 20 (FIG. 2) and engaged in the chamber 14 of the casing 12, and includes an outer peripheral flange 32 extended outwardly from the upper portion 31 thereof for engaging with the membrane 20 directly, or indirectly with a gasket 80 and for anchoring or positioning or attaching or mounting the barrel 30 to the membrane 20, and includes an inner thread 33 formed in the upper portion 31 thereof, and includes a bore 34 formed therein. A lock nut or cap 35 includes a shank 36 extended downwardly therefrom and threaded or engaged with the inner thread 33 of the barrel 30 and engaged with the inner peripheral rim 23 of the membrane 20 for solidly securing the barrel 30 to the membrane 20, and includes an aperture 37 formed therein and communicative with the bore 34 of the barrel 30, and arranged for allowing the water to flow from the outer peripheral space 13 of the housing 10 through the orifice 29 of the membrane 20, and then to flow into the aperture 37 of the cap 35 and the bore 34 of the barrel 30, and then to flow out through the outlet port 15 of the housing 10 (FIG. 2). One or more sealing rings 82 may further be attached to the barrel 30 and engaged with the projections 81 of the barrel 30 for partially blocking the space formed between the barrel 30 and the casing 12.

An inner cover 18 is engaged onto the upper portion 17 of the housing 10 and engaged with the outer peripheral rim 24 of the membrane 20 for forming or defining a sealed compartment 38 (FIG. 2) between the membrane 20 and the inner cover 18, and an outer cover 19 is engaged onto the upper or outer portion of the inner cover 18 and threaded or engaged with the upper portion 17 of the housing 10 for solidly securing the inner cover 18 and the membrane 20 to the upper portion 17 of the housing 10. The compartment 38 of the inner cover 18 is communicative with the aperture 37 of the cap 35 and the bore 34 of the barrel 30 and is also communicative with the outer peripheral space 13 of the housing 10 through the orifice 29 of the membrane 20 for allowing the water to flow from the outer peripheral space 13 of the housing 10 through the orifice 29 of the membrane 20, and then to flow into the aperture 37 of the cap 35 and the bore 34 of the barrel 30.

A valve device 40 is disposed above or higher than the upper portion of the cap 35 and engageable with the cap 35 for selectively blocking or sealing the aperture 37 of the cap 35 and/or the opening 22 of the membrane 20, and for controlling the water to flow from the compartment 38 of the inner cover 18 into or through the aperture 37 of the cap 35 and the bore 34 of the barrel 30. The valve device 40 includes a stem 41 extended downwardly therefrom and extended into or through the aperture 37 of the cap 35 and the bore 34 of the barrel 30, and the aperture 37 of the cap 35 may be selectively opened when the stem 41 of the valve device 40 is tilted relative to the cap 35 and the barrel 30, and may be selectively blocked by the valve device 40 when the stem 41 of the valve device 40 is not tilted relative to the cap 35 and the barrel 30.

An actuating device 50 is attached or secured to the housing 10, and includes an actuating rod 5 1 extended into the housing 10 and engageable with the stem 41 of the valve device 40 for selectively tilting the stem 41 and the valve device 40 relative to the cap 35 and the barrel 30, and thus for selectively opening the aperture 37 of the cap 35 and thus for allowing the water to be controlled to flow from the compartment 38 of the inner cover 18 into or through the aperture 37 of the cap 35 and the bore 34 of the barrel 30. The actuating device 50 includes an actuating handle or lever 52 coupled thereto and extended out of the housing 10 for actuating or operating the actuating rod 51 to selectively tilt the stem 41 and the valve device 40 relative to the cap 35 and the barrel 30, in which the above-described structure of the actuating rod 51 and the actuating handle or lever 52 of the actuating device 50 is not related to the present invention and will not be described in further details.

As shown in FIG. 3, the membrane 20 further includes one or more plugs or gaskets 60 for engaging into or through the orifice 29 of the membrane 20, and the gaskets 60 each include two outer peripheral flanges 61, 62 extended outwardly from the upper portion and the lower portion thereof respectively for engaging with the membrane 20 and for anchoring or positioning the gaskets 60 to the membrane 20, and the gaskets 60 each include an inclined surface 63 formed in one of the outer peripheral flanges 61 for allowing the gaskets 60 to be easily engaged into or through the orifice 29 of the membrane 20, the gaskets 60 may also be easily and quickly disengaged from the membrane 20, and the gaskets 60 include a bore 64, 65, 66 of different inner diameter, and the gaskets 60 of different bores 64, 65, 66 may be easily and quickly changed from each other for adjusting the water flushing quantity or the water flushing speed through the orifice 29 of the membrane 20 and/or through the bores 64, 65, 66 of the gaskets 60.

In operation, as shown in FIG. 2, the stem 41 of the valve device 40 may be selectively tilted relative to the cap 35 and the barrel 30 with the actuating rod 51 and the actuating handle or lever 52 of the actuating device 50 in order to selectively open the aperture 37 of the cap 35 and to allow the water to flow out through the outlet port 15 of the housing 10. In addition, the gaskets 60 of different bores 64, 65, 66 may be easily and quickly changed from each other for adjusting the water flushing quantity or the water flushing speed through the orifice 29 of the membrane 20 and/or through the bores 64, 65, 66 of the gaskets 60. When the actuating handle or lever 52 of the actuating device 50 is released, the water pressure in the compartment 38 of the inner cover 18 and/or in the outer peripheral space 13 of the housing 10 may force the valve device 40 to close or to block or to shut off the aperture 37 of the cap 35 and to prevent the water from flowing out through the outlet port 15 of the housing 10.

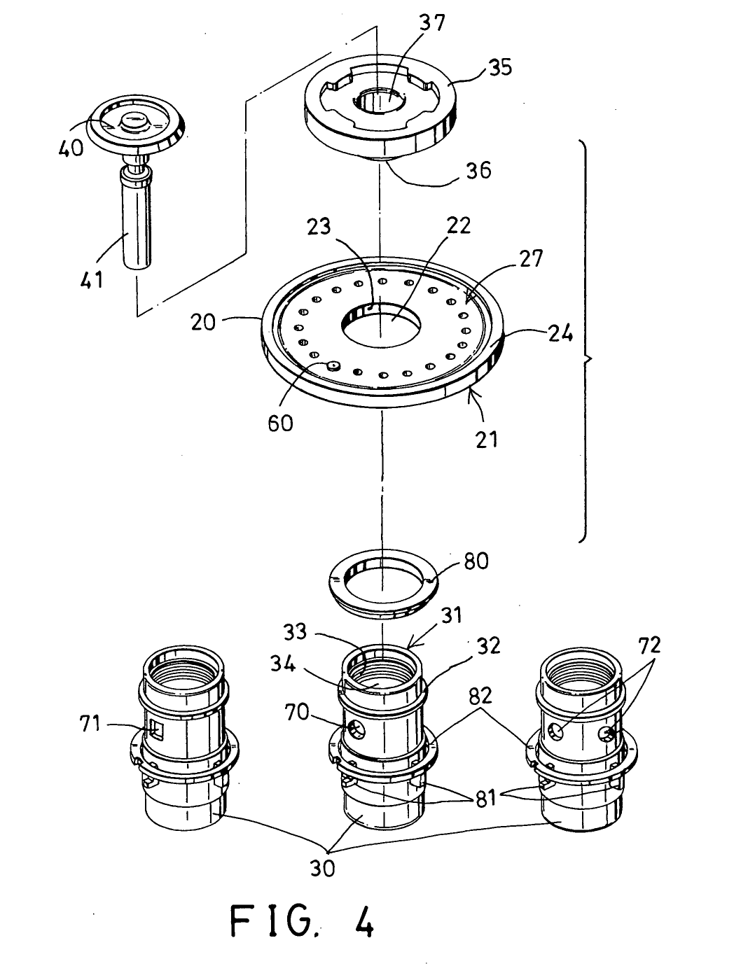

The barrels 30 each further include one passage 70, 71 or more passages 72 formed therein (FIG. 4) and communicative with the bore 34 of the barrel 30 and the chamber 14 of the casing 12 for allowing the water in the bore 34 of the barrel 30 to flow out through the passages 70-72 of the barrel 30 and to flow out into the chamber 14 of the casing 12, and for preventing the valve device 40 from being pushed or opened by the internal water pressure within the bore 34 of the barrel 30. The passages 70, 72 of the barrel 30 may include a circular structure, or a square structure 71. For example, after flushing operation and when the actuating handle or lever 52 of the actuating device 50 is released, the water pressure in the bore 34 of the barrel 30 may be released through the passages 70-72 of the barrel 30 and into the chamber 14 of the casing 12, for preventing the water pressure in the bore 34 of the barrel 30 to keep push or open the valve device 40 and the aperture 37 of the cap 35 and the bore 34 of the barrel 30.

Accordingly, the water flushing device in accordance with the present invention includes an improved structure for allowing the valve device to be suitably blocked or shut off or closed and for preventing the valve device from being kept opened by the internal water pressure.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A water flushing device comprising:
a housing including an inlet port for receiving water, and including an outlet port, and including a casing extended in said housing for forming an outer peripheral space between said housing and said casing, and for forming a bore within said casing, and said outer peripheral space formed and located between said housing and said casing being communicative with said inlet port for receiving the water from said inlet port,
a membrane including an outer peripheral portion engaged onto an upper portion of said housing for blocking said upper portion of said housing, and including an opening formed therein, and including an orifice formed therein,
a valve device for selectively blocking and opening said opening of said membrane, and
a barrel mounted to said membrane and engaged in said chamber of said casing, and including a passage formed therein and communicative with said bore of said barrel and said chamber of said casing for allowing the water in said bore of said barrel to flow out through said passage of said barrel and to flow out into said chamber of said casing.

2. The water flushing device as claimed in claim 1, wherein said barrel includes a bore communicative with said opening of said membrane, and said valve device includes a stem extended into said bore of said barrel.

3. The water flushing device as claimed in claim 2, wherein an actuating device is attached and secured to said housing and includes an actuating rod extended into said housing and engageable with said stem of said valve device for selectively tilting said stem and said valve device relative to said barrel.

4. The water flushing device as claimed in claim 3, wherein said actuating device includes an actuating lever extended out of said housing for operating said actuating rod to selectively tilt said stem and said valve device relative to said barrel.

5. The water flushing device as claimed in claim 1, wherein said membrane includes an inner peripheral rim and an outer peripheral rim for forming and defining a middle peripheral portion between said inner peripheral rim and said outer peripheral rim.

6. The water flushing device as claimed in claim 5, wherein said membrane includes a plurality of bulges formed and located in said middle peripheral portion for reinforcing said membrane.

7. The water flushing device as claimed in claim 5, wherein said membrane includes a blade engaged in said inner peripheral rim for reinforcing said membrane.

8. The water flushing device as claimed in claim 5, wherein said membrane includes a blade engaged in said outer peripheral rim for reinforcing said membrane.

9. The water flushing device as claimed in claim 5, wherein a cover is engaged onto said upper portion of said housing and engaged with said outer peripheral rim of said membrane for forming a sealed compartment between said membrane and said cover.

10. The water flushing device as claimed in claim 5, wherein a cap is engaged with said barrel and engaged with said inner peripheral rim of said membrane for securing said barrel to said membrane.

11. The water flushing device as claimed in claim 1, wherein a first gasket and at least one second gasket are selectively engaged into said orifice of said membrane, and include a bore of different inner diameter for adjusting a water flushing speed through said orifice of said membrane and through said bores of said first and said at least one second gaskets.

12. The water flushing device as claimed in claim 11, wherein said first and said at least one second gaskets each include two outer peripheral flanges for engaging with said membrane and for anchoring said first and said at least one second gaskets to said membrane.

13. The water flushing device as claimed in claim 11, wherein said first and said at least one second gaskets each include an inclined surface formed in one of said outer peripheral flanges for engaging said first and said at least one second gaskets into said orifice of said membrane.
